(19) United States
(12) Patent Application Publication
(10) Pub. No.: US 2015/0258476 A1
(43) Pub. Date: Sep. 17, 2015

(54) FILTERING DEVICE WITH MEASURED ACTIVATION OF FLOW REDUCTION

(71) Applicant: Whirlpool Corporation, Benton Harbor, MI (US)

(72) Inventors: ANDREW BOYCE, Hopkinton, MA (US); Adam Casey, Whitman, MA (US); Steven J. Kuehl, Stevensville, MI (US); Joseph Peters, St. Joseph, MI (US); Mark M. Senninger, St. Joseph, MI (US); Peter Simpson, Holliston, MA (US); Philip Charles Walker, Concord, MA (US)

(73) Assignee: Whirlpool Corporation, Benton Harbor, MI (US)

(21) Appl. No.: 14/658,475

(22) Filed: Mar. 16, 2015

Related U.S. Application Data
(60) Provisional application No. 61/954,167, filed on Mar. 17, 2014.

(51) Int. Cl. B01D 35/143; F25D 23/12; C02F 1/00

(52) U.S. Cl. CPC B01D 35/1435; C02F 1/001; F25D 23/126; C02F 2307/12; C02F 2209/42

(57) ABSTRACT

A method of repeatedly indicating to a user of an appliance that a water filter unit operably connected to the appliance has passed its useful life and a filter unit configure for use in connection with the method where the filter unit includes a fluid flow impeding system within a housing of the filter unit; engaging the filter unit with the appliance; measuring the volume of water treated by the filter unit; activating a fluid flow impeding system contained within the housing of the filter unit; and repeatedly indicating to a user that the maximum volume of water the filter unit has been designed to treat has been surpassed and the filter unit should be replaced by repeatedly delivering a normal flow rate of water from the dispenser of the appliance and thereafter slowing the flow of water from the dispenser of the appliance.

### CROSS-REFERENCE TO RELATED APPLICATIONS

This application claims benefit of U.S. Provisional Application Ser. No. 61/954,167, filed Mar. 17, 2014, entitled FILTERING DEVICE WITH A MEASURED ACTIVATION OF FLOW REDUCTION, the entire contents of which are incorporated herein by reference in its entirety.

### BACKGROUND OF THE INVENTION

The present invention is generally related to a filtration system, more specifically, to a filtration system that includes one or more systems configured to reduce, stop or otherwise alter fluid flow. The water flow is altered to indicate expiration of a filter unit after the filtration system's useful life has passed. The filtration system is typically a water filtration system, more typically a water filtration systems used in connection with an appliance. The appliance is typically a refrigerator.

### BRIEF SUMMARY OF THE INVENTION

An aspect of the present disclosure is generally directed to a method of repeatedly indicating to a user of an appliance that a water filter unit operably connected to the appliance has passed its useful life comprising the steps of: providing a filter unit wherein the filter unit comprises a fluid flow impeding system within a housing of the filter unit; engaging the filter unit with the appliance in a manner such that water received into the appliance from an exterior water source from the appliance enters the filter unit through an inlet aperture and filtered water is delivered out an outlet aperture to a user using a water dispenser of an appliance; measuring the volume of water treated by the filter unit; activating a fluid flow impeding system contained within the housing of the filter unit after a maximum volume of water the filter unit has been designed to treat has been surpassed; and indicating, typically repeatedly indicating as opposed to a one-time indication, to a user that the maximum volume of water the filter unit has been designed to treat has been surpassed and the filter unit should be replaced. When indication is made repeatedly, it is typically done by repeatedly delivering a normal flow rate of water from the dispenser of the appliance and thereafter slowing the flow of water from the dispenser of the appliance upon each activation of the filtered water dispenser by a user.

Yet another aspect of the present disclosure is generally directed toward a filter unit that includes: a main body portion having a distal end portion and an engaging end portion configured to engage a water source and receive water from the water source through a water inlet aperture and deliver treated water out of the filter unit through a water outlet aperture; and a fluid flow impeding system positioned in at least one of (1) the distal end portion or (2) the engaging end portion of filter unit. The fluid flow impeding system is typically engaged with an interior wall of the main body portion such that water passes from the water inlet aperture and out the water outlet aperture passes through the fluid flow impeding system. The fluid flow impeding system typically includes a water impeding valve configured to allow water to flow through the water impeding valve at a normal flow rate until a predetermined volume of water has passed through the fluid flow impeding system and thereafter slow the flow of water through the water impeding valve to a rate less than the normal flow rate and after the predetermined volume of water has passed through the fluid impeding system. The filter unit delivers a period of normal flow rate followed thereafter by a period of reduced flow rate. The water impeding valve is typically positioned within an impeller housing of the fluid flow impeding system and configured to allow an initial normal water flow rate through the water impeding valve into an impeller receiving cavity of the impeller housing that contains an impeller having radially outwardly extending water catching members such that water flowing into the impeller receiving cavity rotationally drives the impeller. The impeller further typically includes at least one magnet that is in magnetic signal communication with a reed switch positioned within an electronics cavity on the opposing side of the impeller receiving cavity housing an on an opposing side of a dividing wall that divides the impeller housing into the electronics receiving cavity and the impeller receiving cavity. The reed switch is typically used to activate at least one water impeding object after the predetermined volume of water has flowed through the filter unit such that the at least one water impeding object slows the water flow through the filter unit to a rate less than the standard operating water flow rate or stops water flow through the filter unit.

Another aspect of the present disclosure is generally directed to an appliance that includes: at least one freezer compartment; at least one fresh food compartment; an exterior water connection that provides water from outside the appliance to the appliance; a filter unit; and a filter head assembly configured to receive a filter unit where the filter unit is configured to be engaged and disengaged with the filter head assembly by hand and without the use of tools. The filter unit that is engaged and disengaged from the appliance typically includes: a main body portion having a distal end portion and an engaging end portion configured to engage a water source and receive water from the water source through a water inlet aperture and deliver treated water out of the filter unit through a water outlet aperture; and a fluid flow impeding system positioned in at least one of (1) the distal end portion or (2) the engaging end portion of filter unit. The fluid flow impeding system is typically engaged with an interior wall of the main body portion such that water passes from the water inlet aperture and out the water outlet aperture passes through the fluid flow impeding system. The fluid flow impeding system typically includes a water impeding valve configured to allow water to flow through the water impeding valve at a normal flow rate until a predetermined volume of water has passed through the fluid flow impeding system and thereafter slow the flow of water through the water impeding valve to a rate less than the normal flow rate and after the predetermined volume of water has passed through the fluid impeding system. The filter unit delivers a period of normal flow rate followed thereafter by a period of reduced flow rate. The water impeding valve is typically positioned within an impeller housing of the fluid flow impeding system and configured to allow an initial normal water flow rate through the water impeding valve into an impeller receiving cavity of the impeller housing that contains an impeller having radially outwardly extending water catching members such that water flowing into the impeller receiving cavity rotationally drives the impeller. The impeller further typically includes at least one magnet that is in magnetic signal communication with a reed switch positioned within an electronics cavity on the opposing side of the impeller receiving cavity housing an on an opposing side of a dividing wall that divides the impeller housing into the electronics receiving cavity and the impeller receiving cavity. The reed switch is typically used to activate at least one water impeding object after the predetermined volume of water has flowed through the filter unit such that the at least one water impeding object slows the water flow through the filter unit to a rate less than the standard operating water flow rate or stops water flow through the filter unit.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is an elevated front view of an exemplary filter unit according to an aspect of the present invention;

FIG. 2 is an exploded view of the structural components of the filter unit of FIG. 1;

FIG. 3 is an elevated end view of the filter unit of FIG. 1;

FIG. 4 is a cross-sectional view of the filter unit taken along the line IV-IV in FIG. 3;

FIG. 5 is an exploded view of a fluid flow impeding system according to an aspect of the present invention;

FIG. 6 is a dual cut away view of the fluid flow impeding system as shown in FIG. 5 in an assembled form;

FIG. 7 is a cross-sectional view of the fluid flow impeding system within the filter unit without the protective material over the electronic components of the system;

FIG. 8 is a cross-sectional view of the fluid flow impeding system within the filter unit with the protective material over the electronic components of the system;

FIG. 9 is a cross-sectional bottom view of the fluid flow impeding system including the electrical components of the system;

FIG. 10 is a cross-sectional top view of the fluid flow impeding system according to an aspect of the present invention;

FIG. 11 is a perspective view of an electrical system according to an aspect of the present invention;

FIG. 12 is a perspective view of an electrical system according to an aspect of the present invention;

FIG. 13 is an elevated front view of the electrical system of FIG. 12;

FIG. 14 is a perspective view of the impeller according to an aspect of the present invention;

FIG. 15 is a front elevational view of the impeller of FIG. 14;

FIG. 16 is a perspective view of an impeller according to another aspect the present invention;

FIG. 17 is a front perspective view of an impeller according to another aspect of the present invention;

FIG. 18 is a front perspective view of the impeller of FIG. 16;

FIGS. 19A-D are each a front perspective view of different configurations of valve feed inserts with various by-pass configurations that allow some amount of flow to continue through the filter unit, but at a reduced rate;

FIG. 20A is a cross-sectional perspective view of a fluid flow impeding system according to an aspect of the present invention prior to the expiration of the useful life of the filter unit;

FIG. 20B is a cross-sectional perspective view of a fluid flow impeding system according to an aspect of the present invention after the useful life of the filter unit showing impeded or stopped flow of water through the filter unit;

FIG. 21A is a cross-sectional perspective view of an alternative fluid flow impeding system according to an aspect of the present invention prior to the expiration of the useful life of the filter unit;

FIG. 21B is a cross-sectional perspective view of an alternative fluid flow impeding system according to an aspect of the present invention prior to expiration after the useful life of the filter unit showing impeded or stopped flow of water through the filter unit;

FIG. 22 is a dual cut away perspective view of a fluid flow impeding system according to an aspect of the present invention generally showing water flow into and out of the system;

FIG. 23 is a dual cut away perspective view of a fluid flow impeding system and according to an aspect of the present invention generally showing water flow into and out of the system showing a more detailed view of water flow as it passes through the fluid flow impeding system, through the filter and out the center outlet;

FIG. 24 is a cross-sectional view of a filter unit according to an aspect of the present invention with the small black arrows showing the water flow path through the system;

FIG. 25 is a bottom left perspective view of an embodiment of a fluid flow impeding system according to an aspect of the present invention;

FIG. 26 is a front elevational view of the housing of FIG. 25 showing the electronic component insulated by a waterproof insulated material;

FIG. 27 is a front elevational view of the housing of FIG. 25 showing the circular water flow direction through an impeller if it were inserted into the system;

FIG. 28 is a perspective view of the housing shown in FIG. 27 with an impeller, according to an aspect of the present invention, fitted within the housing;

FIG. 29 is a front left perspective view of the housing of FIGS. 25-28 with an impeller cover cap positioned over the impeller;

FIG. 30A is a cross-sectional perspective view of a fluid impeding system according to another aspect of the present disclosure prior to the expiration of the useful life of the filter unit using a flap valve to initially permit water flow;

FIG. 30B is a cross-sectional perspective view of a fluid impeding system according to another aspect of the present disclosure after the expiration of the useful life of the filter unit using a flap valve showing the valve in the closed position to inhibit water flow;

FIG. 31A is a cross-sectional perspective view of a fluid impeding system according to another aspect of the present disclosure prior to the expiration of the useful life of the filter unit using a plurality of beads suspended in strands;

FIG. 31B is a cross-sectional perspective view of a fluid impeding system according to another aspect of the present disclosure prior to the expiration of the useful life of the filter unit where the suspended strands of beads shown in FIG. 31A have been released to inhibit water flow;

FIG. 32A is a cross-sectional perspective view of a fluid impeding system according to another aspect of the present disclosure prior to the expiration of the useful life of the filter unit using magnetic beads, typically metallic spherical beads, or other debris engaged to a magnet to initially permit water flow;

FIG. 32B is a cross-sectional perspective view of a fluid impeding system according to another aspect of the present disclosure prior to the expiration of the useful life of the filter unit where the magnetic beads or debris have been released to inhibit water flow;

FIG. 33 is a circuit design according to an aspect of the present invention where the solenoid may be used without a capacitor.

FIG. 34 is an enlarged cross-sectional view of a fluid impeding system according to another aspect of the present disclosure employing a solenoid and plunger/peg system to restrict flow through the filter;

FIG. 35 is a cross-sectional view of the fluid impeding system shown in FIG. 34 spaced within the filter with the arrows showing general water flow through the filter; and

FIG. 36 is a cross-sectional view of the fluid impeding system shown in FIGS. 34 and 35 with the plunger triggered and seated inside a raised ring thereby restricting water flow through a small (about 0.5 mm diameter) hole in the plunger.

### DETAILED DESCRIPTION

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

In this specification and the appended claims, the singular forms “a,” “an” and “the” include plural reference unless the context clearly dictates otherwise.

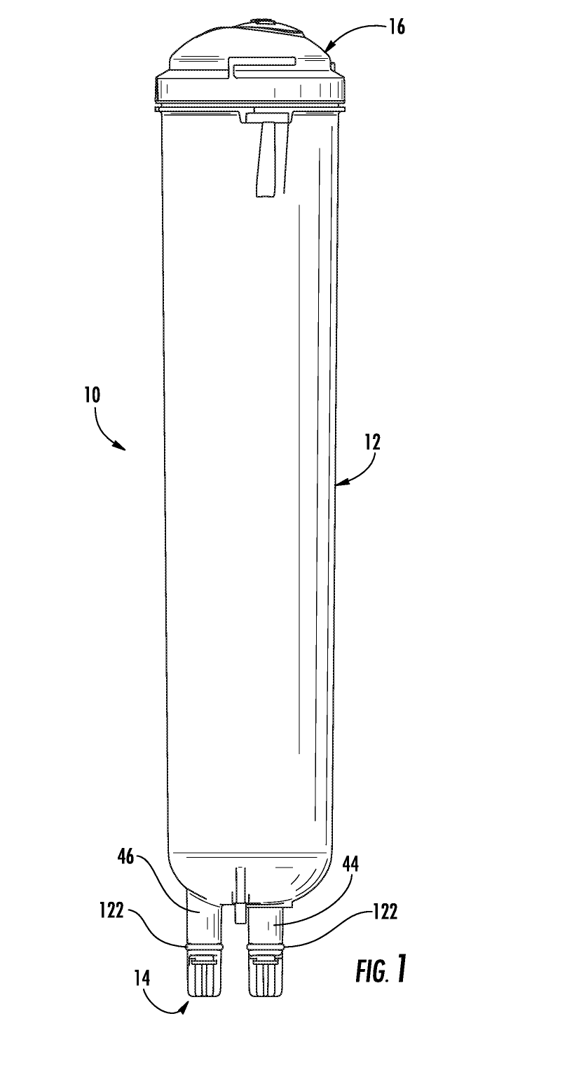

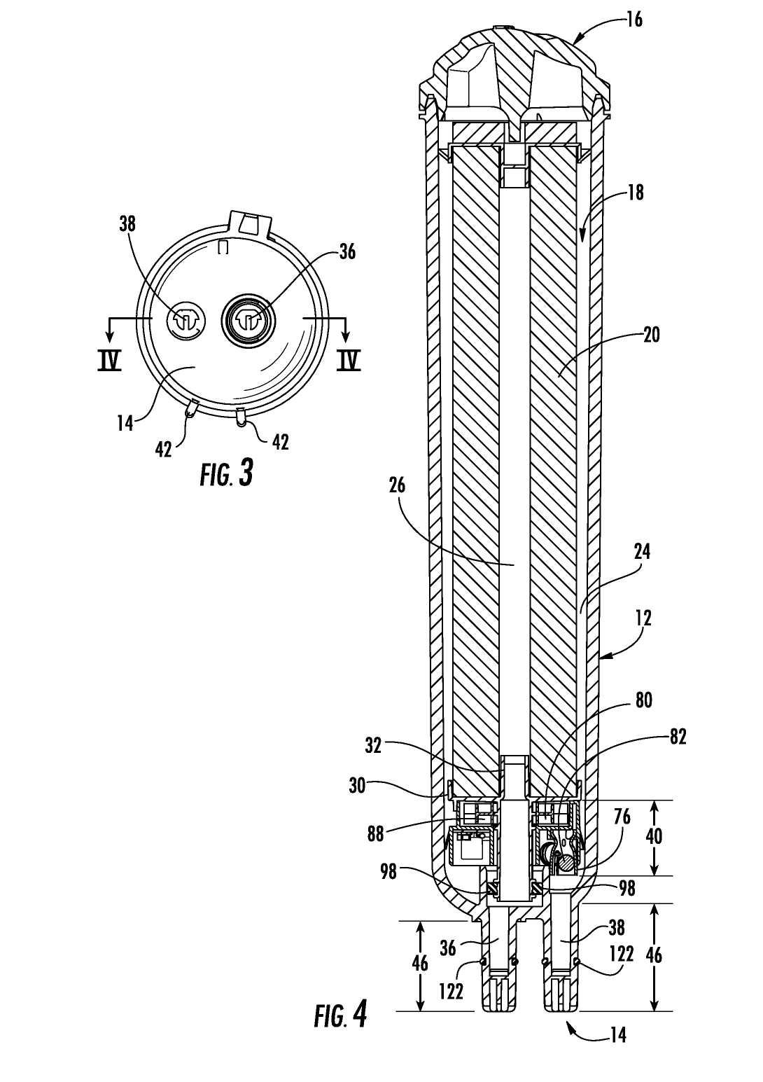

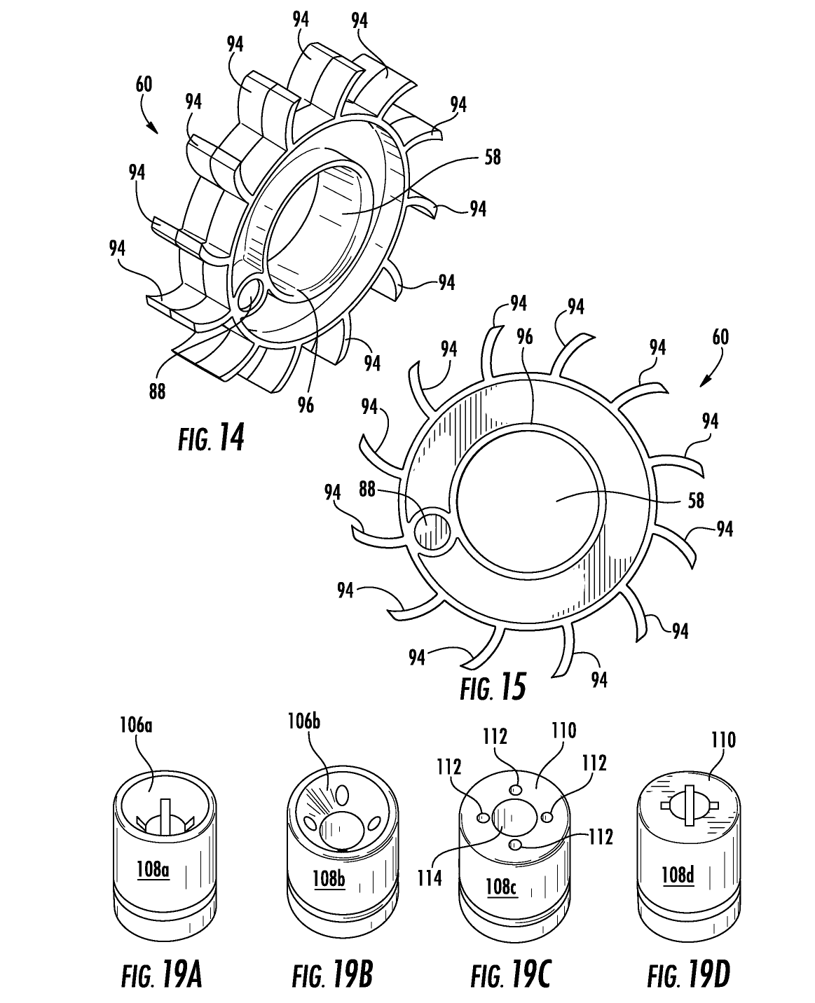

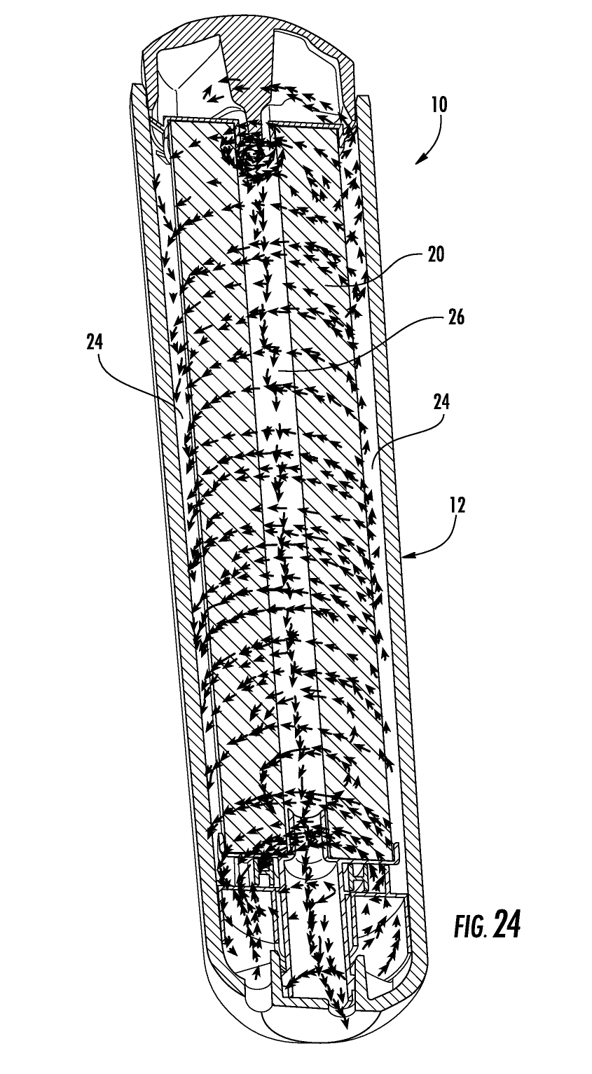

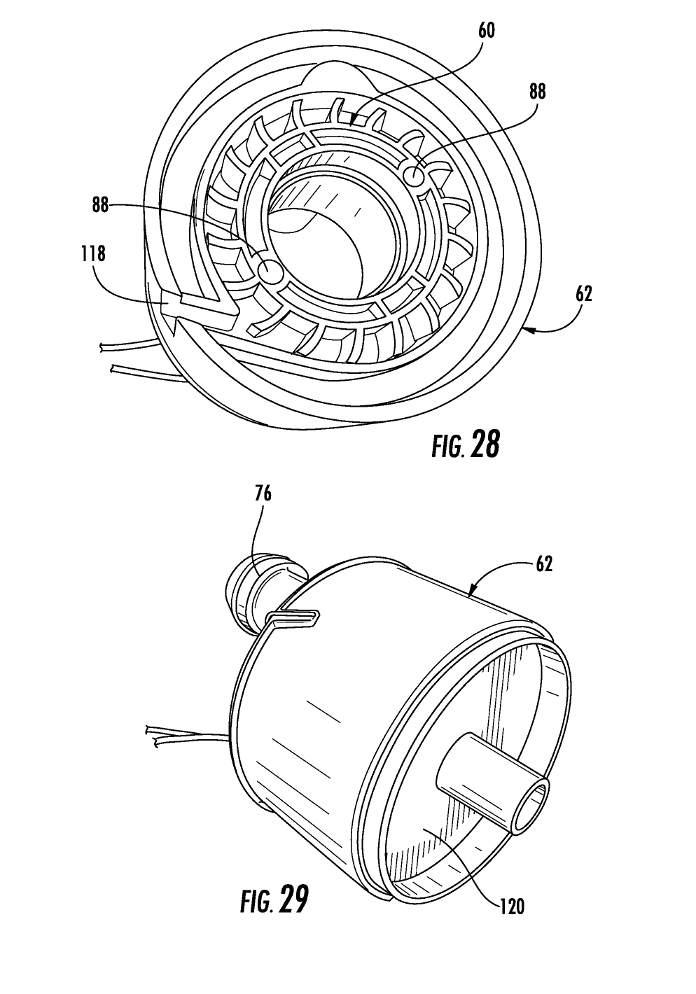

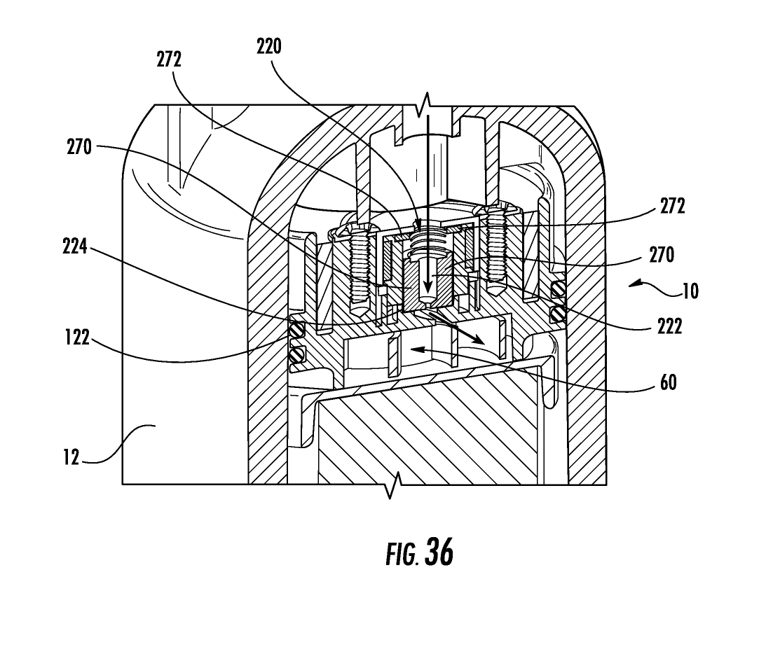

Referring to FIGS. 1-36, a filtration system is generally employed. The filtration system typically includes a filter unit 10 (see FIG. 1). The filter unit typically includes a cylindrical body portion 12 with a water receiving and emitting end 14 and a distal end 16. The filter unit defines an interior volume within the cylindrical body portion between the water receiving and emitting end and the distal end. The filter unit includes a filter media portion 20 disposed within the interior volume 18. The filter media portion has a permeable media wall 22 is faced away from the body portion 12 that defines an exterior passage 24 between the permeable media wall 22 and the body portion 12. The permeable media wall 22 typically surrounds the central axis of the filter media portion 20 and defines an interior passage 26. A filter media engaging cap 28 is typically coupled between the water receiving and emitting end 14 of the filter unit and the body portion 12. The filter media engaging cap 28 typically has a cylindrical filter media engaging trough portion defined by an outer wall 30 and an upwardly extending central axis channel 32. The upwardly extending central axis channel 32 is typically cylindrically shaped in size to matingly engage the interior passage of the filter media portion 20. A second cap 34 also typically contains a filter media engaging portion trough section. The second cap 34 is typically spaced at the opposing end of the filter media portion. The interior passage 26 extends through the filter media engaging cap 28 and operably couples with the outlet aperture 36 to dispense filtered liquid, typically filtered water.

An inlet aperture 38 is operably coupled with the fluid flow impeding system 40 and the exterior passage 24 to deliver unfiltered (unfiltered by the filter unit 10) water into the interior volume of the filter unit 10. The water in the exterior passage passes through and is treated by the filter media portion 20. The filter media engaging cap 28 and the second cap 34 prevent unfiltered from passing from the exterior passage 24 to the interior passage 26 without passing through the filter media portion 20.

The fluid flow impeding system 40 operates to measure the amount (volume) of water passing through the filter unit 10 being delivered as filtered water to the end user. Upon passing of the service life of the filter media portion 20, the fluid flow impeding system 40 operates to impede or stop the flow of fluid through the system. Significantly, the fluid flow impeding system, according to the present invention, typically operates to allow some flow of unfiltered water to flow at a normal rate followed by an impeded or stopped flow shortly thereafter to repeatedly demonstrate to the user that the filter media portion has passed its service life to effectively filter unwanted material from the fluid/water. In this manner, the user is repeatedly notified that the filter has expired while not believing that there is a problem with the system, such as a clogged water conduit in the appliance or other overall problem with the appliance engaged with the filter unit.

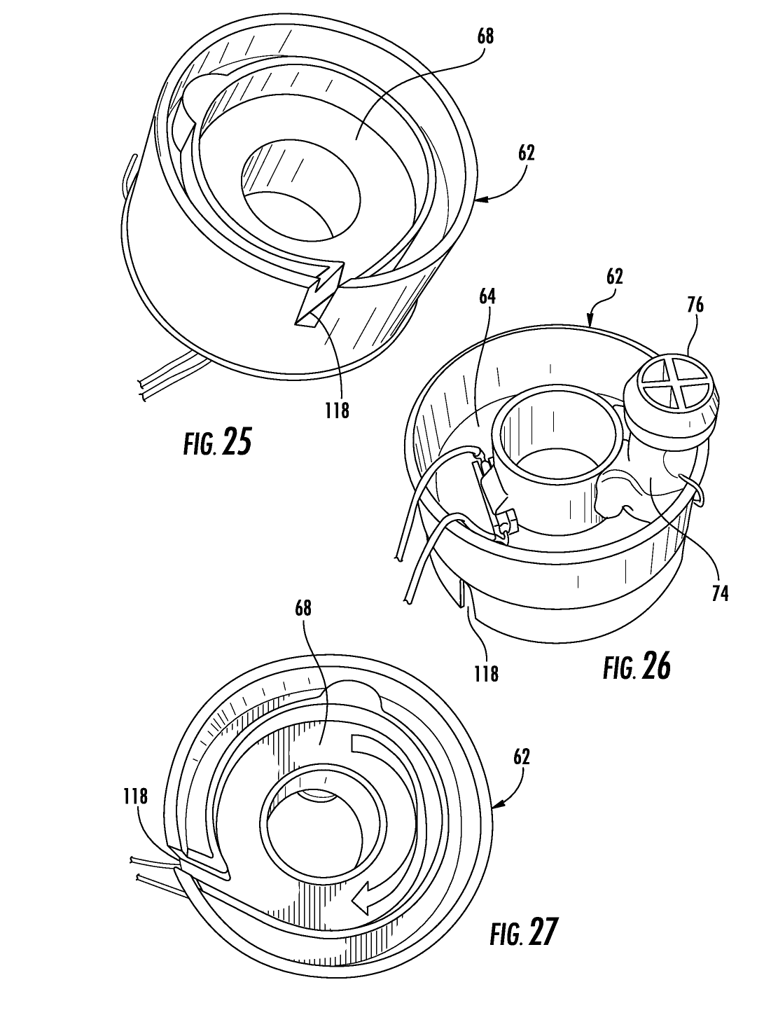

FIGS. 25-29 show an exemplary impeller housing according to an aspect of the present disclosure. FIG. 27 shows the water flow path through the impeller receiving cavity. Water typically flows out of a side aperture 118. FIG. 28 shows the impeller positioned within the impeller receiving cavity 68 of the impeller housing 62. FIG. 29 shows an end cap 120 positioned over the impeller receiving cavity 68.

As shown in various figures, O-rings 122 are used in various locations of the filter unit to ensure a sealing connection between components.

Significantly, in the use of the present filter unit 10, once the useful life of the filter unit has been reached and the volume of water to be treated has been treated, the system not only slows the flow of water to indicate to a user that the filter has passed its useful life, but upon each attempt to dispense water, the filter units of the present disclosure provide a temporary full (normal or approximately normal) flow of water followed by a significantly reduced flow of water. In this manner, each user is repeatedly notified that the filter unit has passed its useful life. This helps prevent a user from believing that there is an overall problem with the appliance itself that may be causing the reduced water flow. Additionally, this provides a repeated indication as opposed to a one time indication of the expiration of the useful life of the water filter. This prevents a circumstance where the reduced water flow is evident to, for example, for a child, which may not be aware that reduced water flow is due to the surpassed useful life of the water filter, but allows for a subsequent user to also receive the indication of the need to replace the filter unit 10 with a new filter unit 10.

The filter unit 10 may have a single engagement protrusion that is typically an oval cross-sectional shape (not shown in the drawings). The engagement protrusion extends longitudinally from the water receiving and emitting end in general alignment with the longitudinal extent of the body portion 12. The engagement protrusion is generally disposed at an offset location on the water receiving and emitting end according to this embodiment of the present disclosure, substantially aligning the outlet aperture with the central axis of the body portion 12. The body portion 12, in this embodiment, typically includes a laterally extending key member that is configured to slidably engage a helical shaped slot on the interior surface of the cylindrical receiver of the filter head assembly to engage the filter unit therewith. Similarly, the body portion includes a helically shaped retention slot to slidably engage a retention member on the filter head assembly.

In the embodiment shown in FIGS. 1-4, the filter unit 10 includes an outlet engagement protrusion 44 longitudinally extending away from the water receiving and emitting end 14 of the filter unit 10. The outlet engagement protrusion 44 has the outlet aperture 36 therein. The water receiving and engagement end 14 also includes an inlet engagement protrusion 46 extending away from the water receiving and emitting end 14 at a location offset from the outlet engagement protrusion 44. The inlet engagement protrusion 46 includes the inlet aperture 38 therein. The inlet and outlet engagement protrusions 44, 46 are configured to engage the inlet and outlet members of the filter head assembly upon longitudinal insertion of the filter unit into the filter head assembly. As such, it is conveyable that other embodiments may include alternative arrangements of the filter unit that are configured to engage with alternative filter head assemblies.

The filter media portion 20 is typically configured to filter and purify water that passes through the media wall 22 such that media filter portion 20 may include filter media such as carbon (e.g., activated carbon particles, such as mesoporous activated carbon, carbon powder, particles sintered with a plastic binder, carbon particles coated with a silver containing material, or a block of porous carbon); ion exchange material (e.g., resin beads, flat filtration membranes, fibrous filtration structures, etc.); zeolite particles or coatings (e.g., silver loaded); polyethylene; charged-modified, melt-blown, or microfiber glass webs; alumina; aluminosilicate material; and diatomaceous earth. The media material may also be impregnated or otherwise disposed on a porous support substrate, such as a fabric material, a paper material, a polymer screen, or other conceivable porous structures that may be contained in the permeable media wall 22 to filter and purify water. It is also conceivable that the filter media portion 20 may be configured to treat water that passes through the media wall 22, whereby the filter media portion may include a treatment media material configured to add a descaling agent to the water, add a vitamin to the water, add a mineral to the water, add a pharmaceutically active agent to the water, and add a color to the water, or mixtures thereof.

The filter media portion 20 is configured to include a service life based upon the types of media material contained therein. The service life may be quantified in the amount of water flow that optimally passes through the filter media portion 20 before the filtration, purification, and/or treatment effects of the media material deteriorate or no longer perform as desired or to the extent desired. The amount of time a filter media may deteriorate either prior to or after being initially exposed to any water flow may also be a factor in the service life of the filter unit. The service life of the filter unit configured to filter and purify water is typically at least 100 to 300 gallons and, more typically 100 to 200 gallons, depending upon the frequency of use and the source water quality.

The filter unit 10, also typically includes a circular support structure 48 that is positioned in engagement with the second cap 34 to provide structural support. The second cap 34 typically includes a downwardly extending nozzle 50 that engages the interior passage 26. The distal end cap 52 engages the distal end of the body portion 12. The distal end cap 52 may threadably engage or permanently be bonded to the distal end of the body portion 12. Most typically, the distal end cap will be engaged to the body portion in manner that would be tamper evident, i.e. if one were to remove the distal end cap, it would be apparent to an end consumer. Alternatively, if one were to remove the distal end cap, the distal cap and/or body portion may be damaged, such that the distal end cap may not be reattached to the body portion 12. In this manner, it prevents tampering with the filter and identifies to the user whether or not tampering has occurred and/or whether or not the filter material may have been altered or replaced.

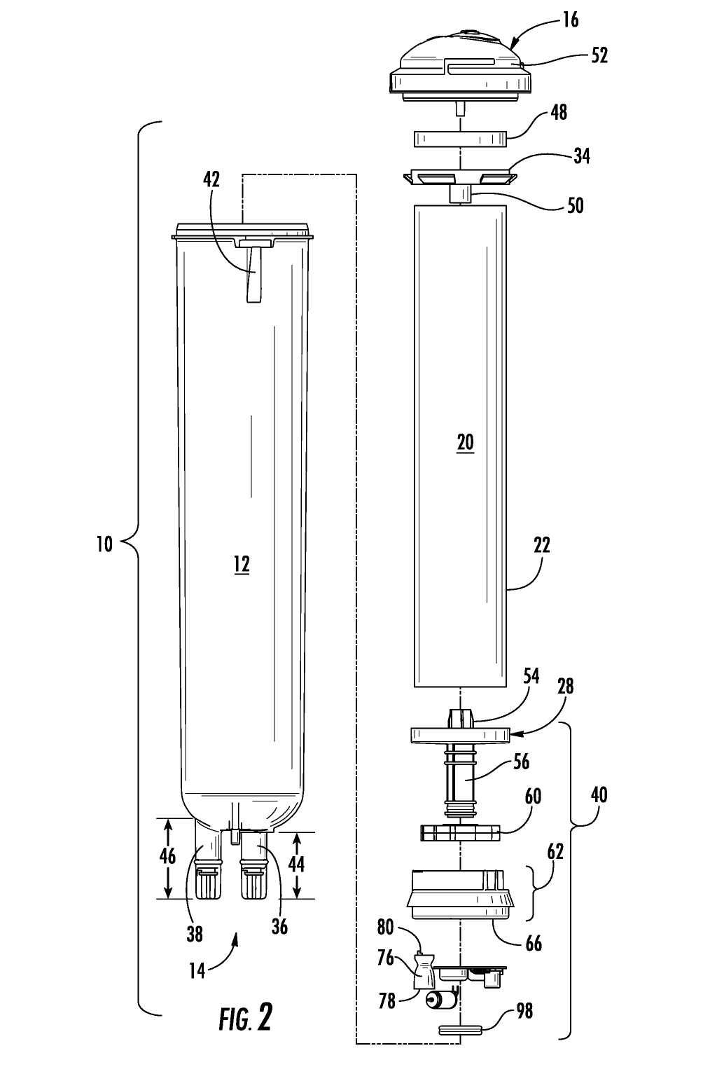

As shown throughout the figures, the present invention also generally includes a fluid flow impeding system 40 that may be placed at either end of the filter unit 10. As shown in FIG. 2, the fluid flow impeding system is positioned proximate the water receiving and emitting end 14, while FIG. 5 shows the fluid flow impeding system 40 positioned at the distal end of the filter unit 10.

Generally speaking, the fluid flow impeding system 40 includes the filter media engaging top cap 28 (shown in FIG. 2). The filter media engaging cap 28 engages one end of the filter media 20, but in FIG. 5, the filter media engaging top cap engages the second cap. In the case of FIG. 5, while not shown, a similar structure that engages the end of the filter media portion 20 proximate the water receiving and emitting end 14 typically would be utilized. The filter media engaging top cap 28 typically includes an upwardly extending nozzle when the filter media engaging top cap engages the filter media; however, when positioned at the distal end, the nozzle 54 may be removed. The filter media engaging cap also typically includes a downwardly extending channel 56 that extends through a center aperture 58 of an impeller 60. The impeller 60 is typically seated within an impeller receiving cavity of an impeller housing 62. The impeller housing 62 also typically has an electronics receiving cavity 64 on a first side 66 and an impeller receiving cavity on a second, opposite side that is opposite the first side. The first side 66 and the second, opposite side 70 are typically divided by a dividing wall. The electronics assembly 72 is typically seated within the electronics receiving cavity 64 and any exposed electronic or power system information is typically encased within a non-toxic, water impermeable material 74. The electronics are “potted”, which is a process of filling an electronic assembly with a solid or gelatinous compound to exclude moisture. Thermosetting plastic, silicone or rubber gels may be used. Projecting downward and allowing water there through is a water impeding valve 76.

The filter unit 10 is typically positioned within a refrigerator appliance according to one aspect of the present disclosure. The refrigerator appliance typically includes an insulated cabinet forming at least one interior freezer compartment and at least one interior refrigerator compartment cooled with at least one refrigeration circuit. The freezer compartment may be arranged below and be separate from the refrigerator compartment and enclosed with a slidable drawer having an insulated door. The freezer compartment may also alternatively be arranged relative to the refrigerator compartment in a side-by-side configuration or with the freezer compartment on top of the refrigerator compartment. In any configuration, the compartments may be accessible by opening and closing hinged doors by hand without use of tools by a person grasping and pulling on a handle on each of the doors. The refrigerator compartment may be enclosed with two hingeable doors in a side-by-side style door arrangement. The left refrigerator door may also include an interactive display, a water dispenser, and an ice dispenser that receives ice from an ice maker positioned somewhere within the appliance or proximate the appliance. The right refrigerator door is also capable of being positioned in an open position when the door is pivoted away from the side wall of the insulated cabinet to expose the interior refrigerator compartment. The refrigerator compartment may also include an alternative enclosure and an alternative location configuration relative to the freezer compartment. It is also conceivable that the refrigerator appliance may alternatively be an appliance with one or more refrigerator compartments and no freezer compartments or only one or more freezer compartments and no refrigerator compartments.

In each embodiment, the appliance may or may not have an ice dispenser or water dispenser, but typically the appliance will have both an ice dispenser and water dispenser. The filter unit 10 is typically operably connected to the appliance to receive water from a water distribution system of the appliance. The water distribution system typically includes a connector on a rear surface of the insulated cabinet of the appliance that couples the appliance with an external water source to supply a water flow to the filter unit 10. Typically, the water supply is a municipal water source or well water source. While the water supply supplied to the appliance prior to being treated by the filter unit 10 may be filtered prior to being treated by the filter unit 10, the water source typically provides unfiltered water to the filter unit 10.

The filter unit typically engages the appliance via a filter head assembly in either a lower grill area on the bottom typically the bottom right below the freezer compartment or an upper panel area above the refrigerator compartment, most typically on the top interior surface of the refrigerator compartment. However, it is conceivable that the filter unit may engage the appliance at any location within or on the exterior surface of the appliance. Further, the filter unit 10 may be used in other applications including other appliances that store, use or dispense any liquid in need of filtration. The liquid to be treated is typically drinking water or water used to form ice. Additionally, the filter unit 10 may be used in connection with a household or standard tap water faucet. When engaged with such a faucet, the engagement is typically at or proximate the faucet outlet or other domestic water source. However, it is conceivable that the filter could be installed intermediate within the water piping of the faucet line between the faucet outlet and the water source.

The body portion 12 of the filter unit 10 is typically cylindrically shaped with a diameter that is capable and configured to be grasped by a hand of a user. Often one or more grasping cutouts or protrusions 42 are included on the exterior surface of the body portion 12. Most typically, the grasping cutouts or protrusions are proximate the distal end 16 (see FIG. 2). This provides a gripping surface for the user to engage and disengage the filter unit from the filter head assembly, which is typically done by rotational and longitudinal movement of the filter unit relative to the filter head assembly.

The filter head assembly typically includes a filter receiving end and water receiving end. The filter receiving end typically has a cylindrical receiver adapted to receive all or at least a portion of the water receiving and emitting end 14 of the filter unit 10. The cylindrical receiver may include an electrical connector that is adapted to engage with and provide electricity and data communication with at least one electronic device that communicates with the filter unit. The cylindrical receiver of the filter head assembly may also include a securing clip that couples with the exterior surface of the body portion 12 of the filter unit 10.

The water receiving end of the filter head assembly typically includes an inlet and an outlet laterally extending on opposite sides of the filter head assembly. The inlet generally couples with the water source via at least one water line that receives water flow from outside the appliance, typically unfiltered water from outside the appliance. In addition, the outlet generally couples with the water dispenser and/or the ice maker within the appliance via at least one water conduit line, typically unfiltered water to the ice maker or for consumption or use by the user. The inlet and outlet of the filter head assembly can be at any angle relative to one another and disposed at any location on the filter head assembly to connect the inlet aperture and the outlet aperture of the filter unit 10.

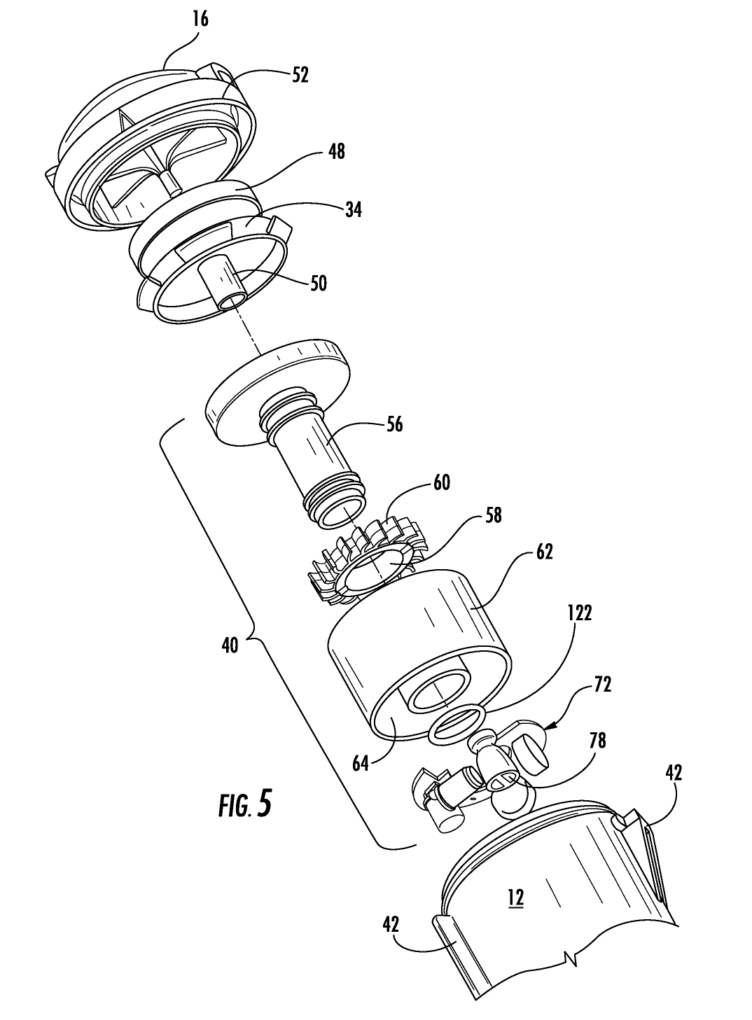

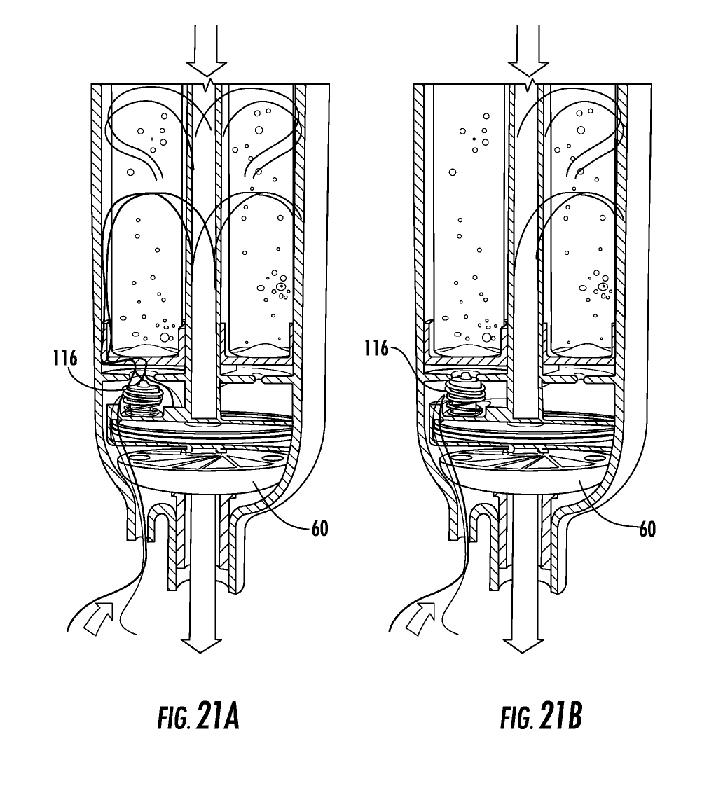

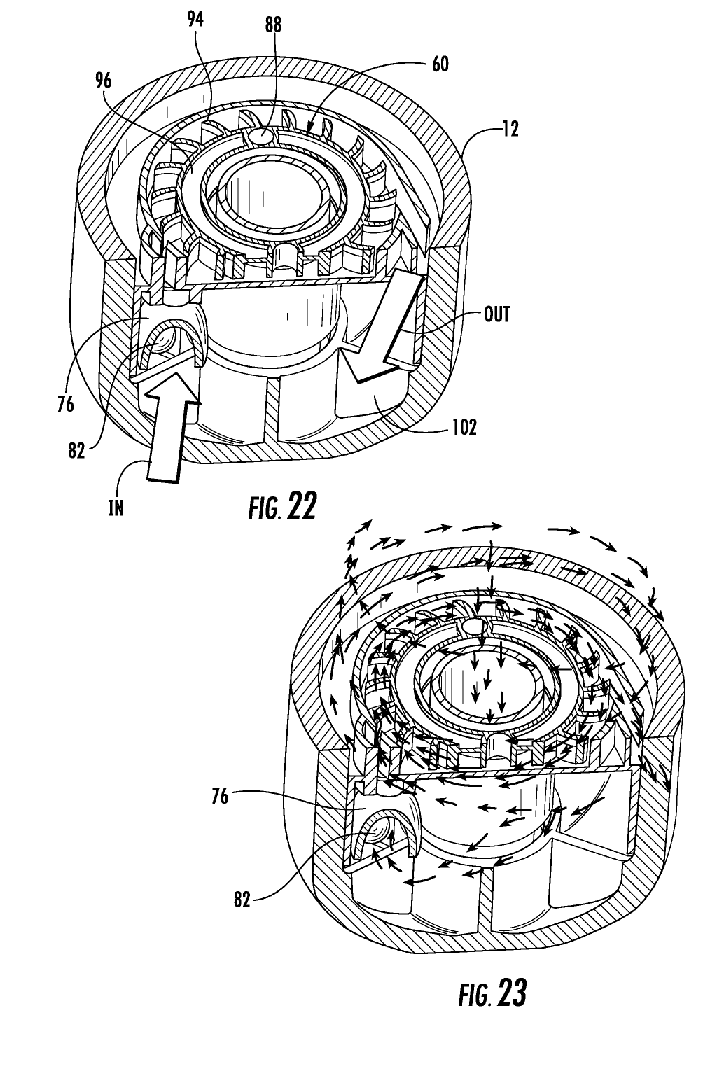

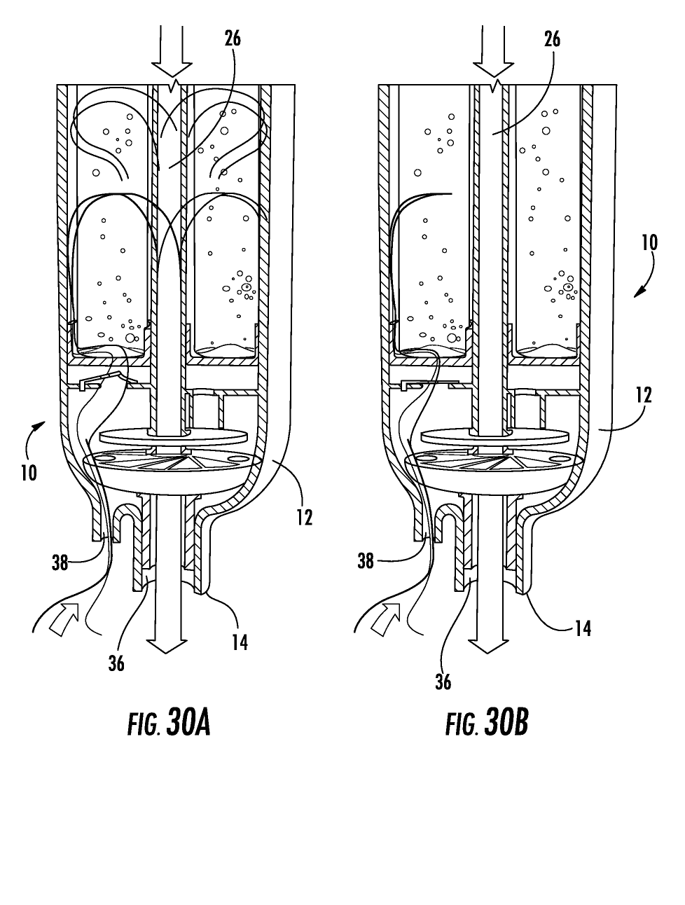

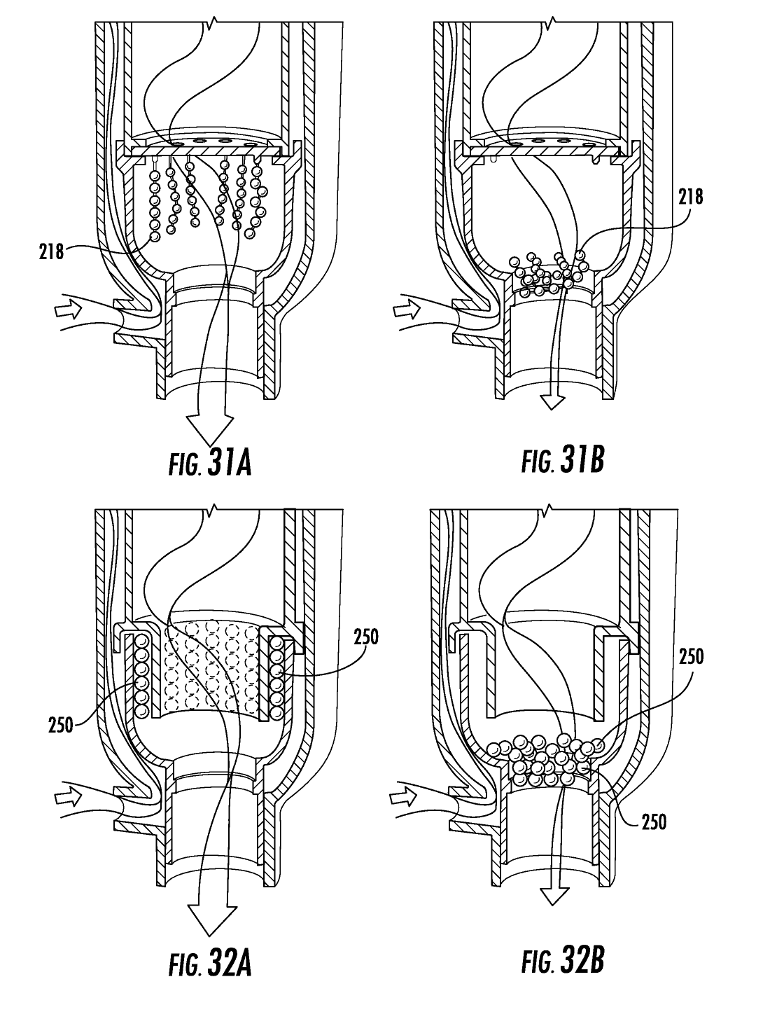

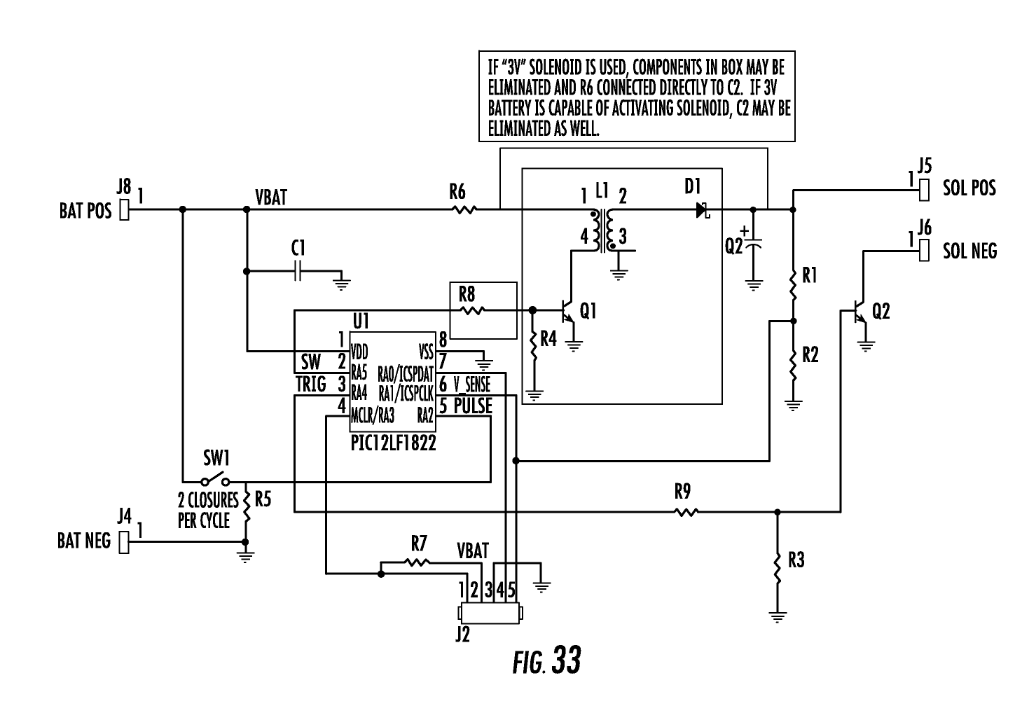

The water impeding valve 76 of the fluid flow impending system 40 typically has an inlet side 78 and an outlet side 80 and is typically positioned in parallel with the central axis of the filter unit; however, numerous shapes and configurations of the valve 76 may be used. Within the water impeding valve is typically a water impeding object 82. A spherical member may be the water impeding object, but the water impeding object may also be one or more of the following: an impeller 60 held stationary by a signal activated breaking mechanism such as a solenoid driven pin driven in between that radially outwardly extending water engaging water engaging fins 94; a plurality of metal debris or metal beads (FIGS. 32A and 32B); a flap valve (FIGS. 30A and 30B); a plurality of beads (FIGS. 31A and 31B) and/or a spring-biased stop or other spring-biased water impeding object (FIGS. 21A and 21B). When the water impeding object is a spherical member as shown in FIGS. 6-10, the sphere is typically retained by the retaining member 84, which is typically a retractable pin. The retractable pin is operably associated with a solenoid 86.

FIGS. 6-10 and 22-24 show the embodiment employing a solenoid and retaining member. In operation, water flows from the water within the impeller housing inlet aperture 38, past the spherical member and into engagement with the impeller 60 thereby spinning the impeller. The impeller 60 typically has one or more magnets 88 enclosed within or positioned on a portion of the impeller. The magnet or magnets 88 operate to communicate with a reed switch that is a component of the electronic's assembly 72 to count or track each time the magnet(s) pass over the reed switch. This allows the filter unit 10 to determine how much (the volume of water) water follows through the filter unit 10.

When the volume of water following through the filter unit 10 surpasses or is approximately the maximum volume capable of being effectively treated by the filter media portion 20, typically a sufficient charge has accumulated in a capacitor 90 of the electronic assembly such that the solenoid is activated or the solenoid itself is activated without the use of a capacitor and the retaining member 84 is retracted by the solenoid. Once the retaining member has been retracted, the water impeding object 82 (spherical member) is allowed to flow along with the water flow flowing through the water impeding valve and moves into engagement with an internal bottleneck portion 92 of the typically hourglass-shaped water impeding valve. As a result, the water flowing through the filter unit 10 is slowed or stopped. Typically, water is allowed to flow through at an approximately 75 to 80% reduced rate from the water flow rate prior to activation of a solenoid and the retracting of the retaining member 84.

The impeller 60 typically has a plurality of water engaging fins 94 that radially extend away from a central hub 96. The water engaging fins are typically curved to capture water flowing through the filter 10 and allow for rotational movement of the impeller in the cylindrical housing of a cylindrically shaped impeller housing 62. While not shown, the fluid flow impeding system shown in FIGS. 6-10 and 22-24 may include one or more water flow channels that are not a water impeding valve. When used the water flow channels ensure that the entire flow of water is not blocked by the spherical member. Rather, depending on the size of the aperture(s) of the water channel(s), a regulated percentage of water less than the normal flow rate will still flow through the filter unit 10.

As discussed above, one or more magnets 88 communicate with a reed switch, which is part of a single sided surface mount circuit board, which is approximately 0.032 inches thick. A reed switch should be in signal communication with the magnet such that the reed switch reads each time the magnet passes over the read. As a result an accurate assessment of the volume of water passing through the filter unit 10 may be made by the filter unit.

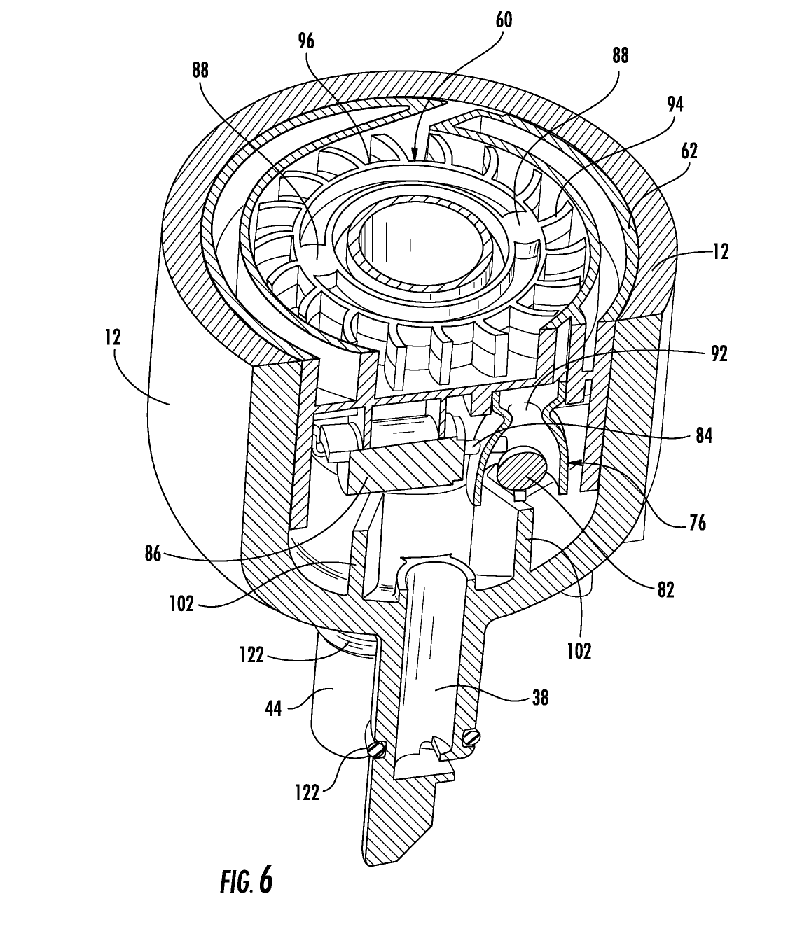

As shown in FIGS. 7 and 8, the impeller housing 62 typically has an integral polypropylene “V” seal 97 that creates an interference seal between the interior side of the body portion 12 and the impeller housing. The “V” seal operates to force water to pass through the impeller. As also shown in FIGS. 7 and 8, a quattro seal 98 is employed to engage the downwardly extending channel 56 to the body portion 12 of the filter unit 10. A quarto seal is a four-lobbed seal with a geometry that provides twice the number of sealing surfaces than a standard O-ring. The quarto seal utilizes squeeze and deflection to affect a seal. The second cap 34 also typically includes integral “V” sealing members 97 positioned circumferentially about the perimeter of the second cap.

As shown in FIG. 9, the electronic assembly 72 of the present disclosure typically includes at least one battery 100. The battery or batteries operate to provide power to the printed circuit board processor and the capacitor. Alternatively, a turbine may be used instead of or in addition to a battery and capacitor to provide the activating electrical power to the other component of the systems of the present disclosure such as the solenoid. Preferably, all of the electrical components are kept on one side of the printed circuit board.

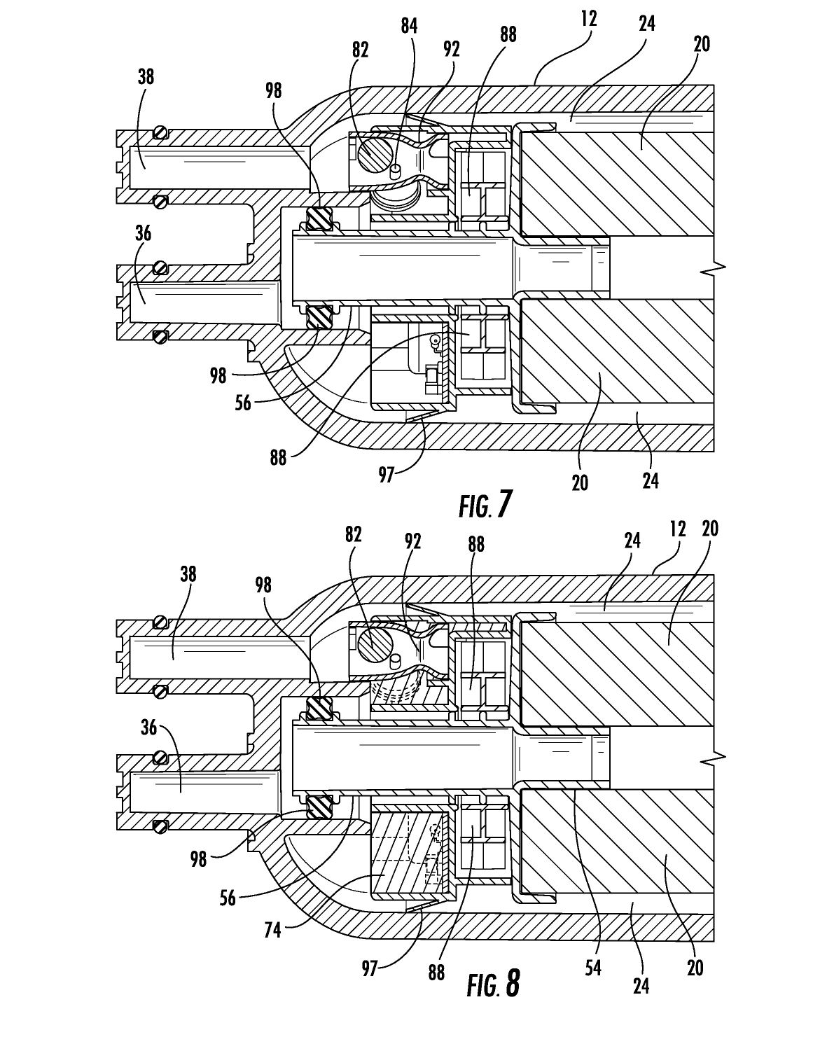

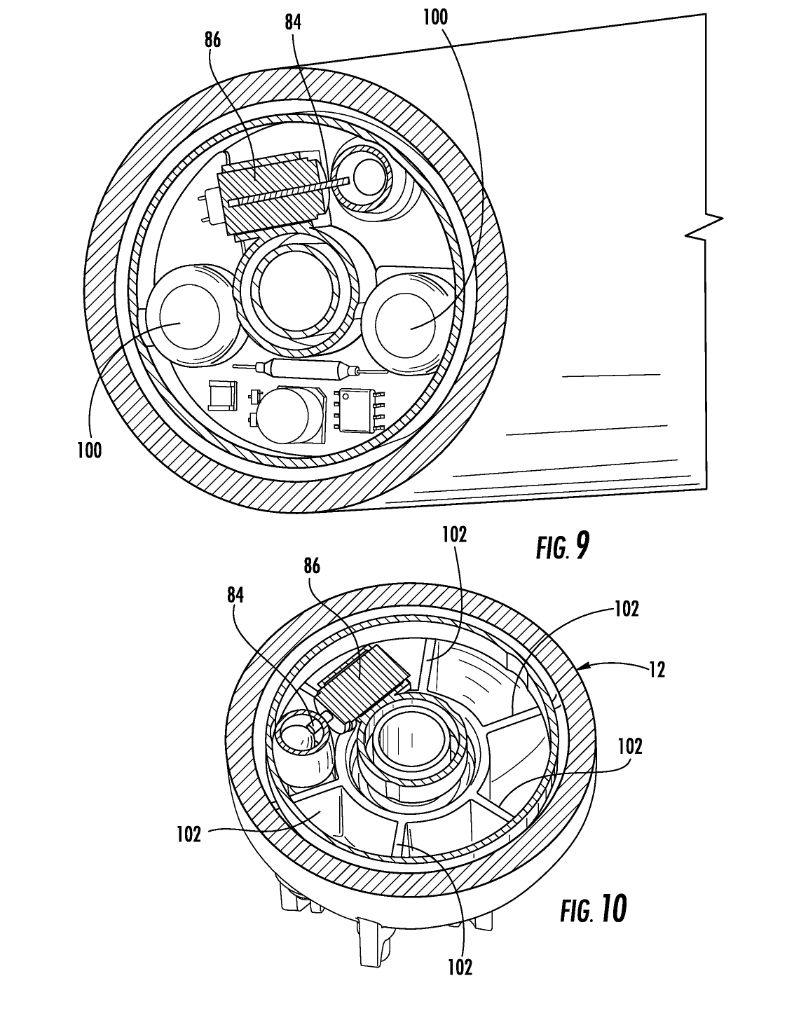

The water impeding valve 76 (see FIG. 10) is typically positioned in between a plurality of ribs 102. The ribs 102 provide structural support. The water impeding valve may also be a funnel shape that fits between the ribs. As shown in the drawings, the water impeding valve is substantially hourglass-shaped.

It will become apparent to those skilled in the art that various modifications to the preferred embodiment of the invention as described herein can be made without departing from the spirit or scope of the invention as defined by the appended claims.

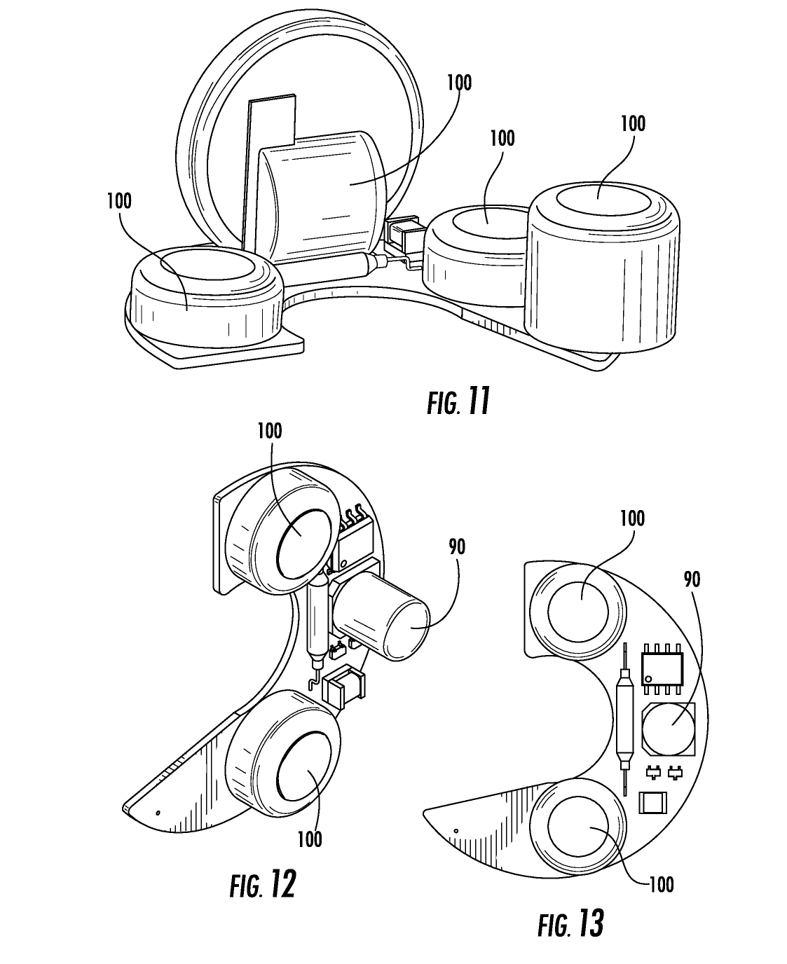

As shown in FIGS. 14-18, the impeller 60 can have various configurations. As shown in FIG. 16, the impeller may be molded such that the magnets are molded within the impeller when the impeller is made of one or more plastic materials. As shown in FIG. 17, the impeller may include a low friction axle 102. FIG. 17 shows magnet receiving apertures 104. The magnets are affixed or molded into the magnet receiving aperture(s) 104. The magnets may be attached via an appropriate adhesive.

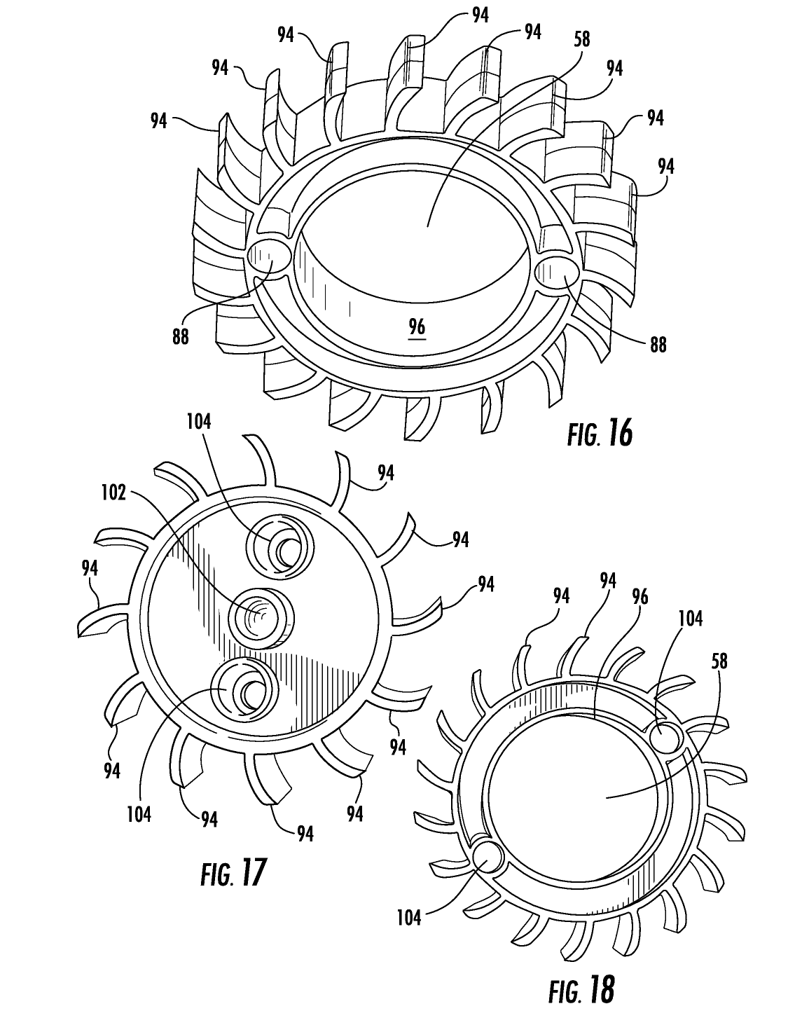

As shown in FIGS. 19A-D, various valve seats may be used in connection with the present disclosure. The valve seats may receive the spherical member or other water impeding object(s) and are typically designed to have the spherical member block the majority of the water flow while allowing some water flow to continue through the valve seats. As shown in FIG. 19A, the spherical member 82 would eventually be seated within the funnel portion 106b of the valve seat inserts 108a. Similarly, the spherical member would be received into the funnel portion 106 of the valve seat 108b shown in FIG. 19B. The valve seat 108c and 108d have a substantially planar spherical member receiving surface 110. As can be seen, there are alternative water flow paths that would not be blocked if a spherical member were brought into engagement with the planar surfaces. For example, in FIG. 19C the peripheral water channels 112 would not be blocked by the spherical members when brought into engagement with the primary center channel 114. Water flow would still be permitted through the valve seat insert. However, a majority of the water flow would be blocked thus slowing the flow of water through the filter assembly and the flowed water being dispensed to the user.

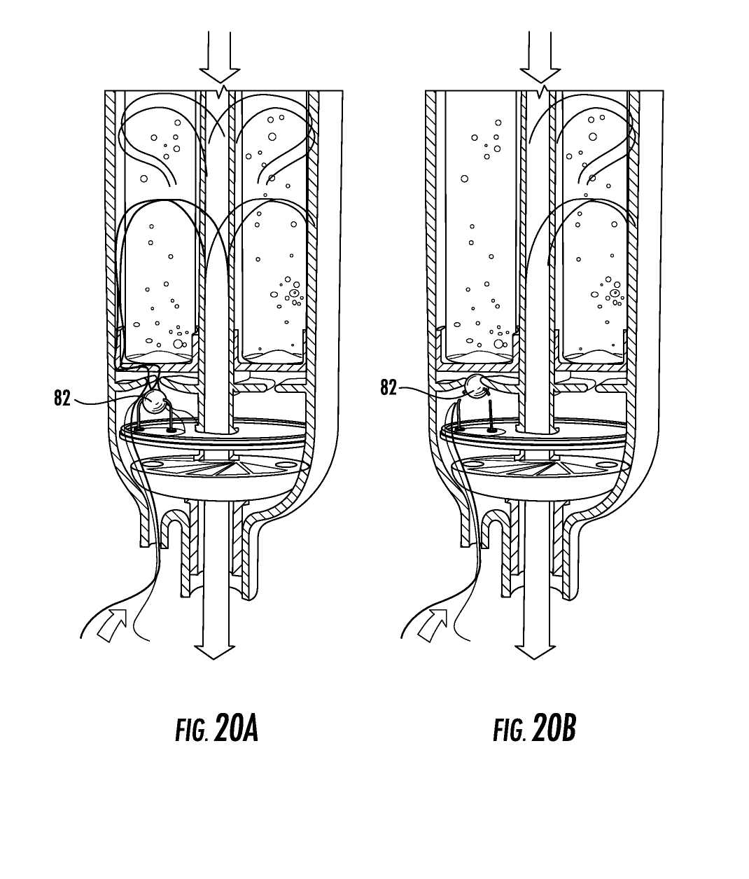

In another aspect of the present disclosure shown in FIGS. 20A and 20B, the electronic assembly 72 operates in the same manner as discussed above. Mainly, the impeller communicates with the reed switch. The capacitor charges to a predetermined level. Once the predetermined level of charge is reached, which corresponds the useful life of the filter media portion of the filter unit, the capacitor discharges and breaks the wire connection (see FIG. 20A) such that the spherical member 82 is allowed to be forced by water flow into engagement with a water flow aperture (see FIG. 20B) and block one of a plurality of such water flow apertures. In this manner, while a majority of water is blocked, some water is still permitted to flow thereby creating a slowed water flow rate.

Yet another aspect of the present disclosure is shown in FIGS. 21A and 21B. These figures show a spring biased impeding object 116 that is biased toward an engaged position and held in a disengaged position with a wire engagement in a similar manner as shown in FIGS. 20A-B. Again, once a predetermined electrical change has been reached after the volume of water that may be effectively treated by the filter unit has passed through the filter unit, the capacitor discharges and releases the spring bias member to block the water passage.

FIGS. 31A and 31B show an alternative fluid impeding system employing utilizing a plurality of suspended strands of beads 218 prior to release (FIG. 31A) and after triggering of the fluid impeding system (FIG. 31B), which results in a slowed water flow through the filter. Once triggered after a predetermined electrical charge has been reached and after the volume of water that may be effectively treated by the filter unit has passed through the filter unit, the capacitor discharges and releases the strands of beads and water flow is inhibited.

FIGS. 32 and 32B show yet another fluid impeding system. The system shown uses a plurality of magnetic beads 250, typically metallic, spherical beads, or other debris that engages a magnet to permit initial “normal” water flow (FIG. 32A) and are disenganged/released form the magnet to inhibit water flow (FIG. 32B). The magnet holding the spherical beads may be an electromagnet that is deactivated once a predetermined electrical change has been reached after the volume of water that may be effectively treated by the filter unit has passed through the filter unit. The deactivation releases the magnetic beads.

FIG. 33 shows how the S-t-F circuit shown might utilize a “3 volt” solenoid. The components in the step-up circuit (boxed) can be removed, and the battery connected directly to the energy storage capacitor, C2, through a current limiting resistor, R6. C2 is now charged to 3V (instead of something more than 5V) and may need to change in value, depending on the energy required to activate the 3V solenoid. If the battery is capable of supplying the necessary current (this translates to the battery's internal resistance being low enough), it may be possible to eliminate C2, and use the battery to activate the solenoid directly. The purpose of R6 is to prevent the solenoid (or step-up circuit, if used) from dropping the battery voltage to zero, which would reset the microprocessor.

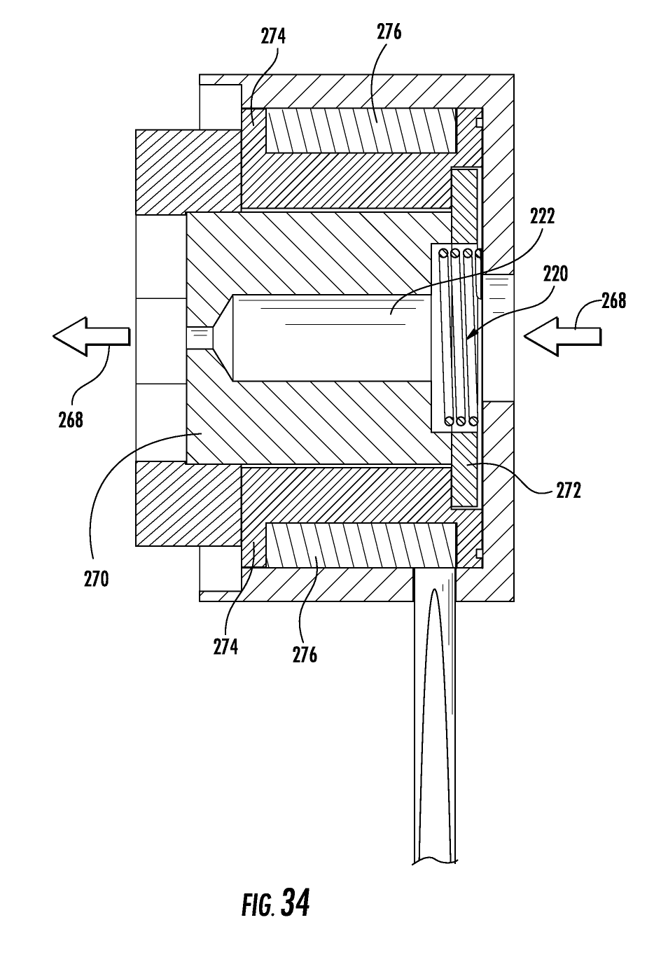

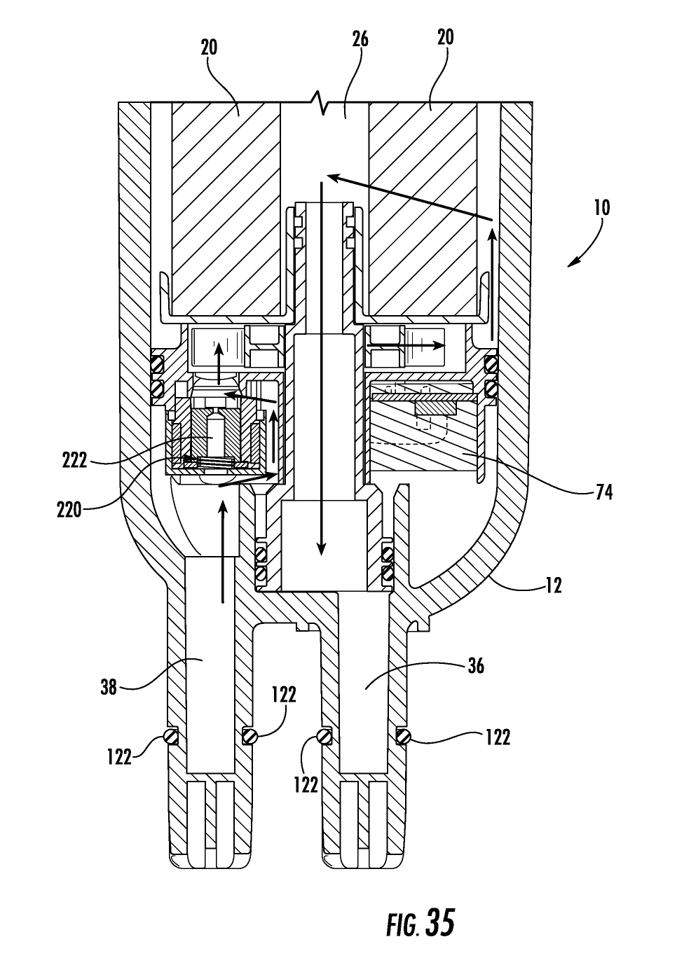

FIGS. 34-36 show another fluid impeding system that uses a solenoid 220 that releases the plunger/peg 222 once a predetermined electrical change has been reached after the volume of water that may be effectively treated by the filter unit has passed through the filter unit, the capacitor discharges and releases the plunger 222. The plunger sits inside a raised ring 224. Water is then restricted via a small (0.5 mm diameter) hole in the plunger. Prior to the seating of the plunger, water is allowed to freely flow underneath the plunger. FIG. 34 shows an enlarged view of the fluid impeding system of this embodiment. Water flows through the system in the direction of the arrows 268. The core 270, magnet 272, bobbin 274 and winding 276 are shown.

It will become apparent to those skilled in the art that various modifications to the preferred embodiment of the invention as described herein can be made without departing from the spirit or scope of the invention as defined by the appended claims.

What is claimed is:

1. A method of repeatedly indicating to a user of an appliance that a water filter unit operably connected to the appliance has passed its useful life comprising the steps of:
providing a filter unit wherein the filter unit comprises a fluid flow impeding system within a housing of the filter unit;
engaging the filter unit with the appliance in a manner such that water received into the appliance from an exterior water source from the appliance enters the filter unit through an inlet aperture and filtered water is delivered out an outlet aperture of a water dispenser to a user using the water dispenser of an appliance;
measuring the volume of water treated by the filter unit;
activating a fluid flow impeding system contained within the housing of the filter unit after a maximum volume of water the filter unit has been designed to treat has been surpassed; and
repeatedly indicating to a user that the maximum volume of water the filter unit has been designed to treat has been surpassed and the filter unit should be replaced by repeatedly delivering a normal flow rate of water from the dispenser of the appliance and thereafter slowing the flow of water from the dispenser of the appliance.

2. The method of claim 1, wherein the fluid flow impeding system comprises a water impeding valve that is in fluid communication with the inlet aperture via a water flow channel and an impeller positioned within an impeller housing and configured to rotate in response to water flowing through the filter unit.

3. The method of claim 2, wherein the impeller housing comprises an electronics receiving cavity on a first side of the impeller housing and an impeller receiving cavity on a second side of the impeller housing and wherein an electronic assembly engaged with at least one water impeding object wherein the electronic assembly is configured to allow the at least one water impeding object to impede the flow of water through the filter unit after the maximum volume of water the filter unit has been designed to treat has been surpassed.

4. The method of claim 3, wherein the at least one water impeding object is chosen from the group consisting of a plurality of beads, a single spherical member, a flap valve, a plunger or combination thereof.

5. The method of claim 4 further comprising the step of using a turbine or at least one battery to deliver a timed electrical charge that is utilized to release a single water impeding object from a full water flow position.

6. The method of claim 5, wherein the timed electrical charge severs one or more wire bonds retaining the single spherical member and releases the single water impeding object allowing the single spherical member to engage a bottleneck portion of the water impeding valve thereby slowing the flow or stopping the flow of water through the filter unit.

7. The method of claim 4, wherein the timed electrical charge, when delivered, is configured to cause at least one of the following:
a) a solenoid to retract a retaining member that retains the single spherical member in the full water flow position;
b) release of a plurality of beads or other debris within the water impeding valve wherein the plurality of beads or the other debris slows or blocks the flow of water through the filter unit; or
c) demagnetize a magnet used to retain metal beads or debris in a full water flow position and allow the metal beads or debris to flow into an obstructing position that slows the flow or stops the flow of water through the filter unit.

8. The method of claim 2, wherein the electronics are potted within the electronics receiving cavity of the impeller housing such that any battery, capacitor, and electrical connection are sealed and shielded from contact with water traveling through the filter unit.

9. The method of claim 2, wherein the fluid flow impeding system is positioned proximate a water receiving and emitting end of the filter unit.

10. The method of claim 2, wherein the fluid flow impeding system is positioned proximate a distal end of the filter unit.

11. The method of claim 3, wherein the impeller contains at least one magnet in magnetic communication with a reed switch.

12. The method of claim 11, wherein the reed switch is positioned within the other electronics in the electronics receiving cavity of the impeller housing and the reed switch is positioned on a printed circuit board and the reed switch is configured to track the volume of water flowing through the filter unit by counting the number of times one or more magnets of the impeller travel past the reed switch.

13. A filter unit comprising:
a main body portion having a distal end portion and an engaging end portion configured to engage a water source and receive water from the water source through a water inlet aperture and deliver treated water out of the filter unit through a water outlet aperture; and
a fluid flow impeding system positioned in at least one of (1) the distal end portion or (2) the engaging end portion of filter unit; and
wherein the fluid flow impeding system is engaged with an interior wall of the main body portion such that water passing from the water inlet aperture and out the water outlet aperture passes through the fluid flow impeding system and the fluid flow impeding system includes a water impeding valve configured to allow water to flow through the water impeding valve at a normal flow rate until a predetermined volume of water has passed through the fluid flow impeding system and thereafter slow the flow of water through the water impeding valve to a rate less than the normal flow rate and after the predetermined volume of water has passed through the fluid impeding system; and
wherein the water impeding valve is positioned within an impeller housing of the fluid flow impeding system and configured to allow an initial normal water flow rate through the water impeding valve into an impeller receiving cavity of the impeller housing that contains an impeller having radially outwardly extending water catching members such that water flowing into the impeller receiving cavity rotationally drives the impeller and the impeller further comprises at least one magnet that is in magnetic signal communication with a reed switch positioned within an electronics cavity on the opposing side of the impeller receiving cavity housing an on an opposing side of a dividing wall that divides the impeller housing into the electronics receiving cavity and the impeller receiving cavity; and
wherein the reed switch triggers the activation of at least one water impeding object after the predetermined volume of water has flowed through the filter unit.

14. The filter unit of claim 13, wherein the filter unit delivers a period of normal flow rate followed thereafter by a period of reduced flow rate and wherein the reed switch is in electrical signal communication with a capacitor to release a charge and sever a wire connecting the capacitor and the at least one water impeding object thereby releasing the water impeding object from a full water flow position to a water impeding position within the water impeding valve.

15. The filter unit of claim 14, wherein a charging device chose from the group consisting of: one or more batteries and one or more water flow driven turbines.

16. The filter unit of claim 15, wherein the charging device is at least one battery operably connected to a printed circuit board and wherein the capacitor and the reed switch are operably connected to the printed circuit board.

17. The filter unit of claim 14, wherein the impeller housing further comprises an unimpeded waterway that allows water to flow through the impeller housing of the fluid flow impeding system after the predetermined volume of water has passed through the fluid flow impeding system.

18. An appliance comprising:
at least one freezer compartment;
at least one fresh food compartment;
an exterior water connection that provides water from outside the appliance to the appliance;
a filter unit; and
a filter head assembly configured to receive a filter unit wherein the filter unit is configured to be engaged and disengaged with the filter head assembly by hand and without the use of tools; and
wherein the filter unit comprises:
a main body portion having a distal end portion and an engaging end portion configured to engage a water source and receive water from the water source through a water inlet aperture and deliver treated water out of the filter unit through a water outlet aperture; and
a fluid flow impeding system positioned in at least one of (1) the distal end portion or (2) the engaging end portion of filter unit; and
wherein the fluid flow impeding system is engaged with an interior wall of the main body portion such that water passing from the water inlet aperture and out the water outlet aperture passes through the fluid flow impeding system and the fluid flow impeding system includes a water impeding valve configured to allow water to flow through the water impeding valve at a normal flow rate until a predetermined volume of water has passed through the fluid flow impeding system and thereafter slow the flow of water through the water impeding valve to a rate less than the normal flow rate and after the predetermined volume of water has passed through the fluid impeding system, the filter unit delivers a period of normal flow rate followed thereafter by a period of reduced flow rate after the predetermined volume of water has passed through the filter unit;
wherein the water impeding valve is positioned within an impeller housing of the fluid flow impeding system and configured to allow an initial normal water flow rate through the water impeding valve into an impeller receiving cavity of the impeller housing that contains an impeller having radially outwardly extending water catching members such that water flowing into the impeller receiving cavity rotationally drives the impeller and the impeller further comprises at least one magnet that is in magnetic signal communication with a reed switch positioned within an electronics cavity on the opposing side of the impeller receiving cavity housing an on an opposing side of a dividing wall that divides the impeller housing into the electronics receiving cavity and the impeller receiving cavity; and
wherein the reed switch triggers the activation of at least one water impeding object after the predetermined volume of water has flowed through the filter unit.

19. The filter unit of claim 18, wherein the reed switch is in electrical signal communication with a capacitor to release a charge and sever a wire connecting the capacitor and the at least one water impeding object thereby releasing the water impeding object from a full water flow position to a water impeding position within the water impeding valve.

20. The filter unit of claim 19 further comprising a charging device, wherein the charging device is at least one battery operably connected to a printed circuit board and wherein the capacitor and the reed switch are operably connected to the printed circuit board and wherein the impeller housing further comprises an unimpeded waterway that allows water to flow through the impeller housing of the fluid flow impeding system after the predetermined volume of water has passed through the fluid flow impeding system.
